(19) United States
(12) Patent Application Publication
(10) Pub. No.: US 2020/0009602 A1
(43) Pub. Date: Jan. 9, 2020

(54) METHOD OF PRODUCING DISPLAY PANEL

(71) Applicant: Sharp Kabushiki Kaisha, Sakai City (JP)

(72) Inventors: Kohshiroh TANIIKE, Sakai City (JP); Kohichi ARIKI, Sakai City (JP); Tomonari IKEDA, Sakai City (JP)

(21) Appl. No.: 16/446,689

(22) Filed: Jun. 20, 2019

Related U.S. Application Data
(60) Provisional application No. 62/693,483, filed on Jul. 3, 2018.

(51) Int. Cl. B05C 5/02; B05D 7/24; B05B 1/30

(52) U.S. Cl. CPC B05C 5/0233; B05D 1/26; B05B 1/30; B05D 7/24

(57) ABSTRACT

A method of producing a display panel using a seal dispenser including a nozzle and discharging sealing material onto the substrate, the sealing material applied onto the substrate having a sealing material cross-sectional area cut along a plane orthogonal to a nozzle moving direction and a spacing between the substrate and a tip of the nozzle being defined as a nozzle gap. The method includes a determining step of determining the nozzle diameter and the nozzle gap corresponding to the target sealing material cross-sectional area based on a linear function that approximates a relationship between a product of a nozzle diameter and the nozzle gap and the sealing material cross-sectional area, and a sealing material applying step executed after the determining step and applying the sealing material onto the substrate through the nozzle having the nozzle diameter determined in the determining step while maintaining the nozzle gap determined in the determining step.

### CROSS REFERENCE TO RELATED APPLICATION

This application claims priority from U.S. Provisional Patent Application No. 62/693,483 filed on Jul. 3, 2018. The entire contents of the priority application are incorporated herein by reference.

### TECHNICAL FIELD

The present technology described herein relates to a method of producing a display panel.

### BACKGROUND

Conventionally, after the application of a sealing material onto one of a pair of substrates that constitute a display panel, the sealing material is sandwiched between the pair of substrates by putting the other substrate on top of the substrate. Japanese Unexamined Patent Application Publication No. 2009-50828 discloses a configuration in which a sealing material discharged from a nozzle by the rotational pressure of a screw is applied onto a substrate.

In applying a sealing material through the use of a nozzle, there is a case where the cross-sectional area of a sealing material applied onto a substrate is set as a targeted value. The cross-sectional area of a sealing material varies according to various parameters regarding the nozzle and a screw. For this reason, for the application of a sealing material with a desired cross-sectional area onto the substrate, it is necessary to specify parameters correlated with the cross-sectional area of the sealing material and set these parameters.

### SUMMARY

The present technology described herein was made in view of the above circumstances. An object is to provide a method of producing a display panel that makes it possible to apply a sealing material with a desired cross-sectional area onto a substrate.

The present technology is related to a method of producing a display panel using a seal dispenser that includes a nozzle and moves over a substrate of the display panel while discharging a sealing material onto the substrate to apply the sealing material onto the substrate, the sealing material applied onto the substrate having a sealing material cross-sectional area that is a cross-sectional area of the sealing material cut along a plane orthogonal to a moving direction of the nozzle and a spacing between the substrate and a tip of the nozzle being defined as a nozzle gap. The method includes a determining step of determining, on the basis of a linear function that approximates a relationship between a product of a nozzle diameter of the nozzle and the nozzle gap and the sealing material cross-sectional area, the nozzle diameter and the nozzle gap that correspond to the sealing material cross-sectional area that is targeted, and a sealing material applying step of, by using the nozzle having the nozzle diameter determined in the determining step, applying the sealing material onto the substrate while maintaining the nozzle gap determined in the determining step, the sealing material applying step being executed after the determining step.

There is a correlation between the product of the nozzle diameter and the nozzle gap and the sealing material cross-sectional area and this correlation can be approximated by a linear function. For this reason, by determining, on the basis of such a linear function, a nozzle diameter and a nozzle gap that correspond to the target sealing material cross-section area and applying the sealing material onto the substrate on the basis of the nozzle diameter and nozzle gap thus determined, the sealing material can be applied with a desired cross-sectional area onto the substrate.

According to the present technology described herein, a method of producing a display panel with which a sealing material can be applied onto a substrate with a desired cross-sectional area is provided.

### BRIEF DESCRIPTION OF THE DRAWINGS

FIG. 1 is a cross-sectional view schematically showing a configuration of a liquid crystal display device.

FIG. 2 is a plan view showing a sealing material applying step.

FIG. 3 is a cross-sectional view (which corresponds to a view taken along line III-III in FIG. 2) showing a sealing dispenser and the sealing material applying step.

FIG. 4 is a chart showing combinations of a nozzle gap and a nozzle diameter with respect to targeted sealing material cross-sectional areas.

FIG. 5 is a graph showing a correlation between nozzle diameters and sealing material cross-sectional areas.

FIG. 6 is a graph showing a correlation between the products of a nozzle diameter and a nozzle gap and sealing material cross-sectional areas.

FIG. 7 is a chart showing a correlation between screw rotational speeds and variations in sealing material cross-sectional area.

FIG. 8 is a graph showing a correlation between screw rotational speeds and variations in sealing material cross-sectional area (with a nozzle diameter of 0.2 mm).

FIG. 9 is a graph showing a correlation between screw rotational speeds and variations in sealing material cross-sectional area (with a nozzle diameter of 0.3 mm).

FIG. 10 is a graph showing a correlation between screw rotational speeds and variations in sealing material cross-sectional area (with a nozzle diameter of 0.4 mm).

FIG. 11 is a graph showing a correlation between screw rotational speeds and variations in sealing material cross-sectional area (with a nozzle diameter of 0.5 mm).

### DETAILED DESCRIPTION

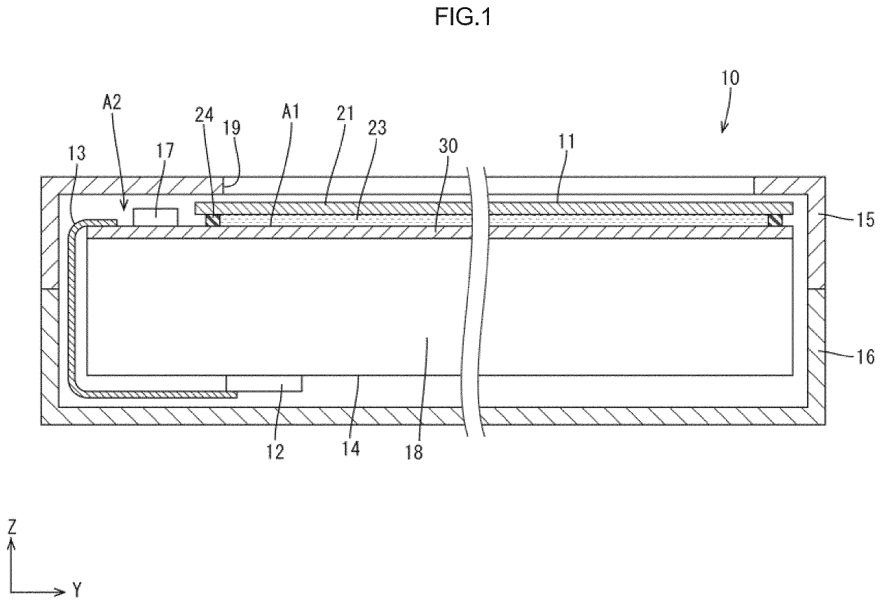

An embodiment is described with reference to FIGS. 1 to 11. As shown in FIG. 1, a liquid crystal display device includes a liquid crystal panel 11 (display panel), a control circuit board 12 that supplies various types of input signal to a driver 17 of the liquid crystal panel 11, a flexible substrate 13 that electrically connects the liquid crystal panel 11 and the external control circuit board 12 to each other, and a backlight device 14 (lighting device) serving as a light source that supplies the liquid crystal panel 11 with light. As shown in FIG. 1, the backlight device includes a chassis 18 having a substantially box shape having an opening facing forward (toward the liquid crystal panel 11), a light source (such as a cold-cathode tube, or an LED, or organic EL) placed in the chassis 18, and an optical member disposed in such a manner as to cover the opening of the chassis 18. The optical member has a function of, for example, converting light emitted by the light source into planar light. The liquid crystal panel 11 has a display region A1 that is capable of displaying an image and a non-display region A2 that surrounds the display region A1.

Further, as shown in FIG. 1, the liquid crystal display device 10 includes a pair of front and back exterior members 15 and 16 for accommodating the liquid crystal panel 11 and the backlight device 14. The front exterior member 15 has an opening 19 through which to view, from the outside, an image displayed in the display region A1 of the liquid crystal panel 11. The liquid crystal display device 10 according to the present embodiment is one that is used in various types of electronic apparatus such as mobile phones (including smartphones and the like), laptop personal computers (including tablet laptop personal computers and the like), wearable terminals (including smartwatches and the like), mobile information terminals (including electronic books, PDAs, and the like), mobile game machines, and digital photo frames.

As shown in FIG. 1, the liquid crystal panel 11 includes a pair of substrates 21 and 30 placed opposite each other, a liquid crystal layer 23 (medium layer), placed between the pair of substrates 21 and 30, that contains liquid crystal molecules constituting a substance whose optical properties vary with the application of an electric field, and a sealing material 24 that seals in the liquid crystal layer 23 by being placed between the pair of substrates 21 and 30 and surrounding the liquid crystal layer 23. The pair of substrates 21 and 30 consist of a front (in FIG. 1, upper) substrate serving as a CF substrate 21 (counter substrate) and a back substrate serving as an array substrate 30 (active matrix substrate). The CF substrate 21 includes a glass substrate and a color filter and the like stacked on an inner surface of the glass substrate. The color filter includes colored portions of three colors, namely R (red), G (green), and B (blue), arranged in a matrix. Further, polarizing plates are pasted to outer surfaces of the substrates 21 and 30, respectively.

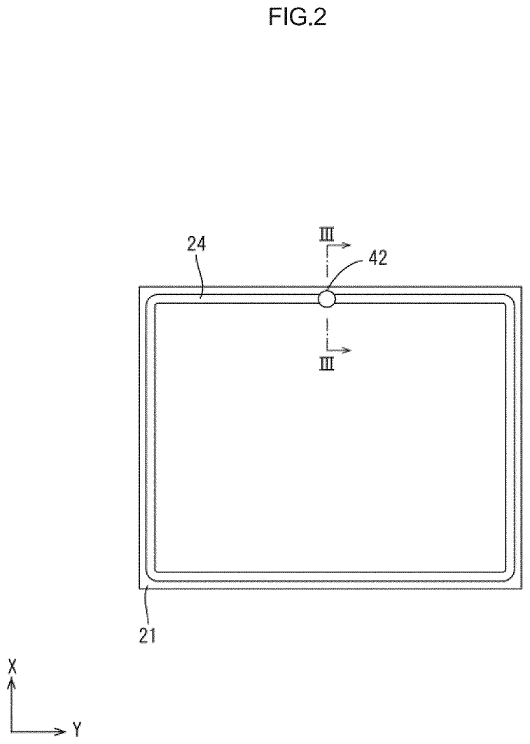

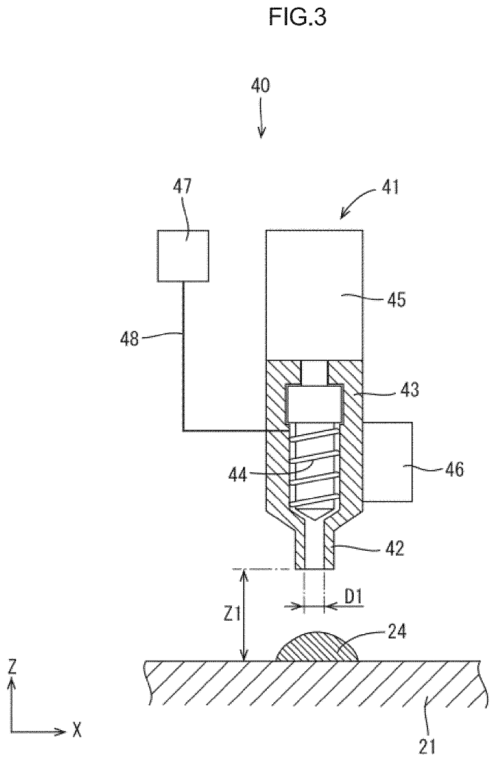

As shown in FIG. 2, the sealing material 24 has a square frame shape. The sealing material 24 is applied, for example, onto the CF substrate 21 by using a seal dispenser shown in FIG. 3. Examples of a material of which the sealing material 24 is made include photo-curable resin, thermosetting resin, and the like. As shown in FIG. 3, the seal dispenser 40 includes an application head 41. The application head 41 includes a cylinder 43 having a nozzle 42 for discharging the sealing material 24, a screw 44 built in the cylinder 43, a motor 45 that causes the screw 44 to rotate, a position sensor 46 provided on the cylinder 43, a storage container 47 in which to store the sealing material 24, and a pipe 48 connecting the cylinder 43 and the storage container 47 to each other. Further, the seal dispenser 40 includes a moving apparatus that enables the application head 41 to move in a horizontal direction and a vertical direction. Further, the present embodiment includes a plurality of the nozzles 42 whose discharge holes differ in diameter (nozzle diameter D1) from one another. This makes it possible to change from one nozzle diameter D1 to another by replacing one nozzle 42 with another.

In this configuration, the screw 44 rotates to cause the sealing material 24 in the cylinder 43 to be extruded by the screw 44, with the result that the nozzle 42 discharges the sealing material 24 from inside the cylinder 43. Moreover, the nozzle 42 moves over the CF substrate 21 while discharging the sealing material 24. This makes it possible to apply the sealing material 24 onto the CF substrate 21. Further, the position sensor 46 is for example a laser displacement meter and makes it possible to measure a nozzle gap Z1, which is a spacing between a tip of the nozzle 42 and the CF substrate 21. This allows the moving apparatus to, in accordance with a signal from the position sensor 46, move the application head 41 while maintaining the nozzle gap Z1. It should be noted that a screw-type seal dispenser such as that of the present embodiment is more suitable to applying a highly thixotropic and highly viscous sealing material than an air-type sealing dispenser.

In applying the sealing material 24 onto the CF substrate 21, a targeted sealing material cross-sectional area S1 is set, and parameters concerning the seal dispenser are set so as to approach the target sealing material cross-sectional area S1. The “sealing material cross-sectional area S1” here is the area of a cross-section (see FIG. 3) cut along a plane orthogonal to a direction of movement of the nozzle 42 (i.e. a direction of drawing of the sealing material 24), and is proportional to the discharge rate of the sealing material 24.

As a result of diligent study, the following two findings (1) and (2) were obtained about three parameters (the nozzle diameter D1, the nozzle gap Z1, and the rotational speed V1 of the screw 44) that affect the sealing material cross-sectional area S1 of the parameters concerning the seal dispenser 40.

Finding (1): A relationship between the product M1 of the nozzle diameter D1 and the nozzle gap Z1 and the sealing material cross-sectional area S1 can be approximated by a linear function.
Finding (2): In a case where the rotational speed V1 of the screw 44 is set within the range of 48 rpm to 96 rpm (2000 pps to 4000 pps), variations in the sealing material cross-sectional area S1 are small.

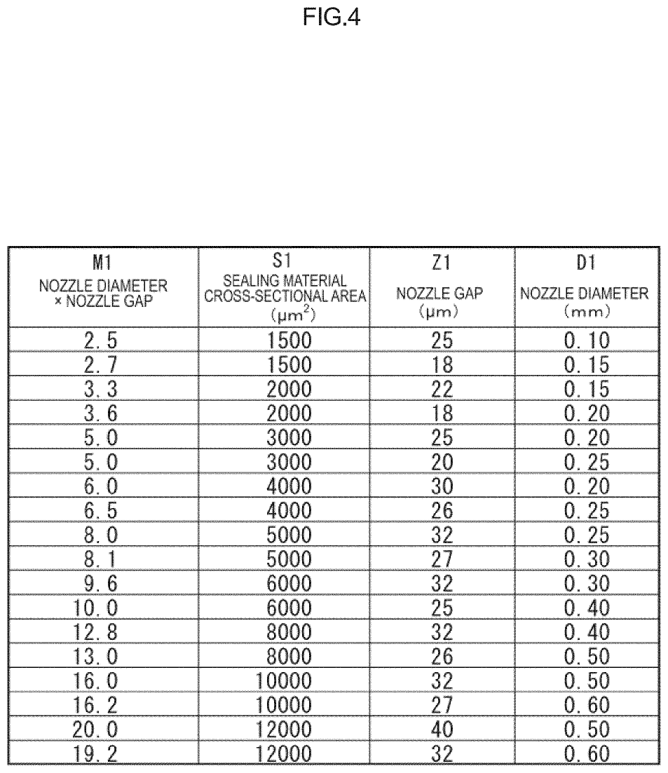

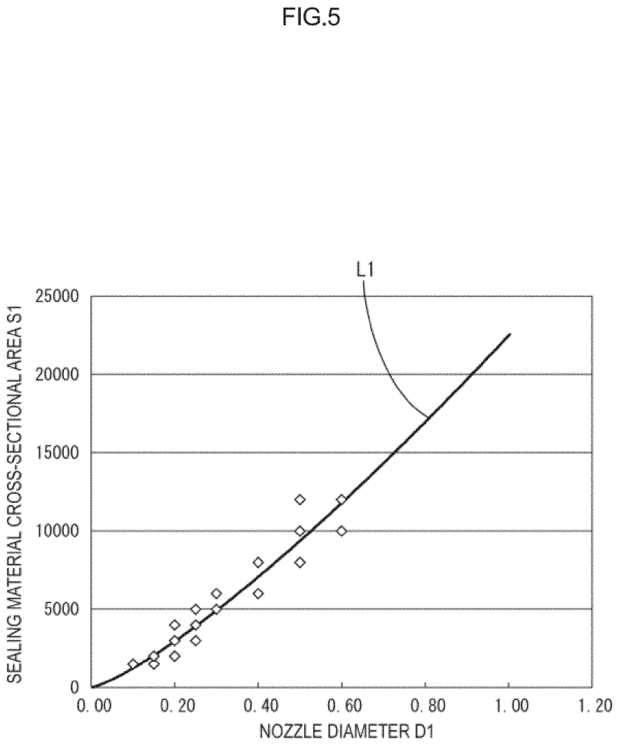

Regarding the finding (1), the sealing material 24 was applied onto test substrates with varied nozzle gaps Z1 and nozzle diameters D1 and measured the resulting sealing material cross-sectional areas S1. By so doing, a combination of a nozzle gap Z1 and a nozzle diameter D1 that gives a sealing material cross-sectional area S1 that is closest to the targeted sealing material cross-sectional area S1 was specified. FIG. 4 shows the result. It should be noted that FIG. 4 shows a result yielded in a case where the rotational speed V1 of the screw 44 is 3000 pps. FIG. 5 is a graph on which the nozzle diameter D1 and the targeted sealing material cross-sectional area S1 are plotted about the measurements of FIG. 4. In FIG. 5, the horizontal axis represents the nozzle diameter D1, and the vertical axis represents the sealing material cross-sectional area S1. As shown in FIG. 5, as the nozzle diameter D1 becomes larger, the sealing material cross-sectional area S1 becomes larger. Further, the curve L1 of FIG. 5 is a curve that represents a relational expression (in the present embodiment, S1=22481*D1^{1.263}) between the nozzle diameter D1 and the sealing material cross-sectional area S1 as calculated using the method of least squares. It should be noted that the curve L1 of FIG. 5 is a power approximate curve.

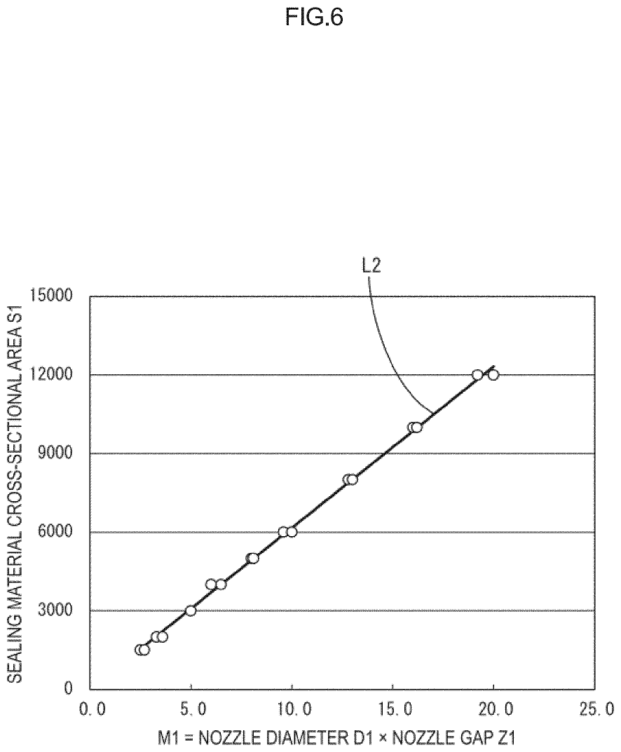

Further, according to FIG. 4, as the nozzle gap Z1 becomes larger, the sealing material cross-section area S1 becomes larger, with the nozzle diameter D1 being the same. FIG. 6 is a graph on which the product M1 of the nozzle diameter D1 and the nozzle gap Z1 and the targeted sealing material cross-sectional area S1 are plotted about the measurements of FIG. 4. In FIG. 6, the horizontal axis represents the product M1 of the nozzle diameter D1 and the nozzle gap Z1, and the vertical axis represents the sealing material cross-sectional area S1. As shown in FIG. 6, there is a correlation between the product M1 of the nozzle diameter D1 and the nozzle gap Z1 and the sealing material cross-sectional area S1, and the relationship between the product M1 and the sealing material cross-sectional area S1 can be approximated by a linear function (i.e. the equation of the line L2 of FIG. 6; in the present embodiment, S1=616.18*M1).

Moreover, a comparison between FIGS. 5 and 6 shows that FIG. 6 shows a smaller error between the approximate line and the actual measurement data. That is, it is found that the relational expression prepared on the basis of the product M1 and the sealing material cross-sectional area S1 is higher in approximation accuracy than the relational expression prepared on the basis of the nozzle diameter D1 and the sealing material cross-sectional area S1. That is, an error of the sealing material cross-sectional area S1 with respect to the target value can be reduced by setting the nozzle diameter D1 and the nozzle gap Z1 than by setting only the nozzle diameter D1 with respect to the targeted sealing material cross-sectional area S1. It should be noted that the R-2th power value of the equation of the curve L1 is 0.9121 and the R-2th power value of the equation of the line L2 is 0.9982.

Further, regarding the finding (2), a correlation between the rotational speed V1 of the screw 44 and variations in the sealing material cross-sectional area S1 was examined. Variations in the sealing material cross-sectional area S1 were calculated according to the following procedures (1) and (2).

Procedure (1): The sealing material cross-sectional area S1 of a linear portion of the sealing material 24 was measured at three points at intervals of 10 mm in a direction of movement of the nozzle 42 (i.e. a direction of drawing of the sealing material 24), and the difference between the maximum and minimum values of the three measurements was taken as a variation E1 in the sealing material cross-sectional area S1. This variation E1 was calculated for each sealing material cross-sectional area S1 with varied rotational speeds V1 and nozzle gaps Z1. It should be noted that the rotational speed V1 was varied in increments of 500 pps in the range of 1000 pps to 8000 pps, and the nozzle gap Z1 was varied in increments of 2 μm in the range of, for example, 20 μm to 50 μm. That is, basically, for each type of rotational speed V1, sixteen variations E1 were calculated with varied nozzle gaps Z1. Further, the speed of movement of the nozzle 42 was 150 mm/sec.

Procedure (2): For each type of rotational speed V1, the average of all variations E1 with varying nozzle gaps Z1 was taken as a variation E2, and this variation E2 was calculated for all types (fifteen types) of rotational speed V1.

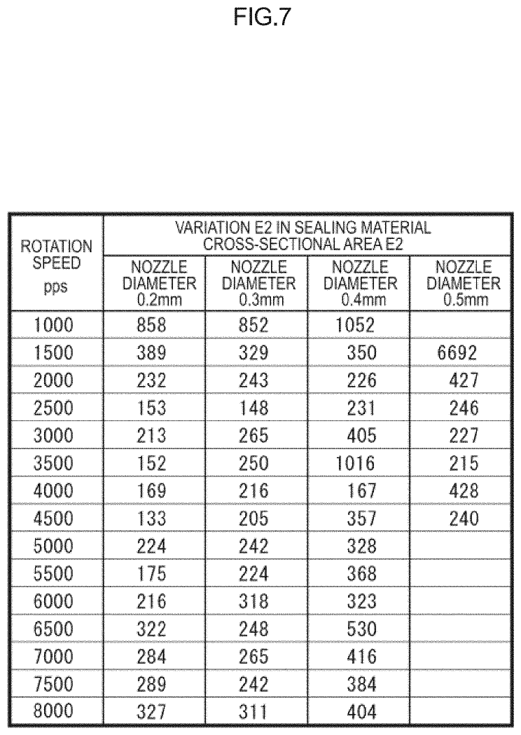

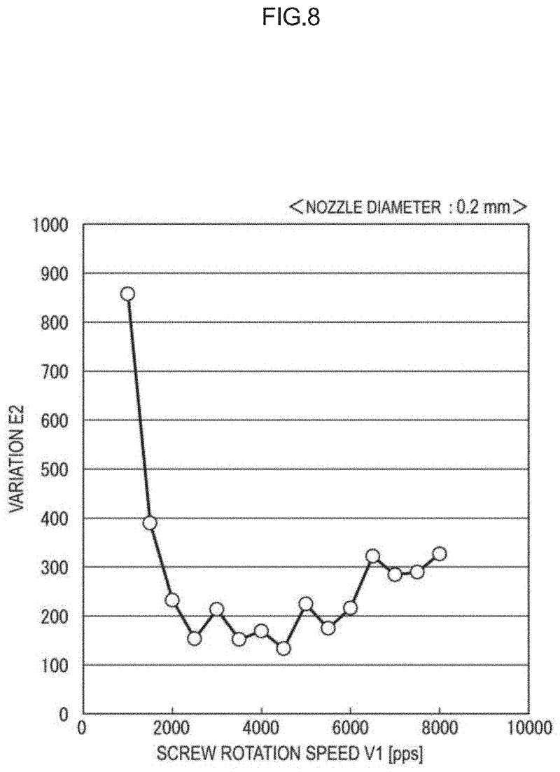

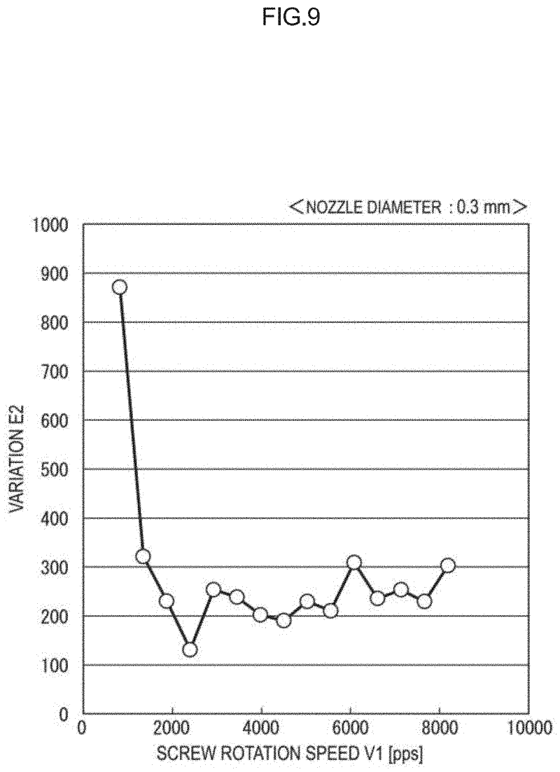

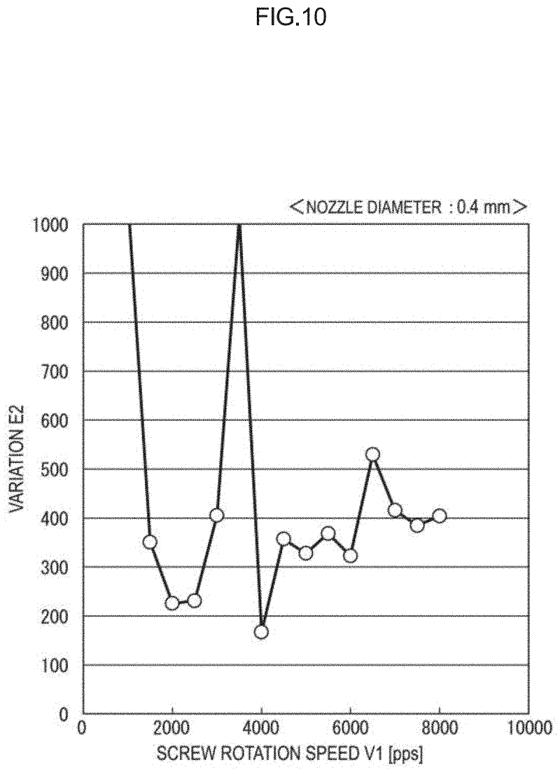

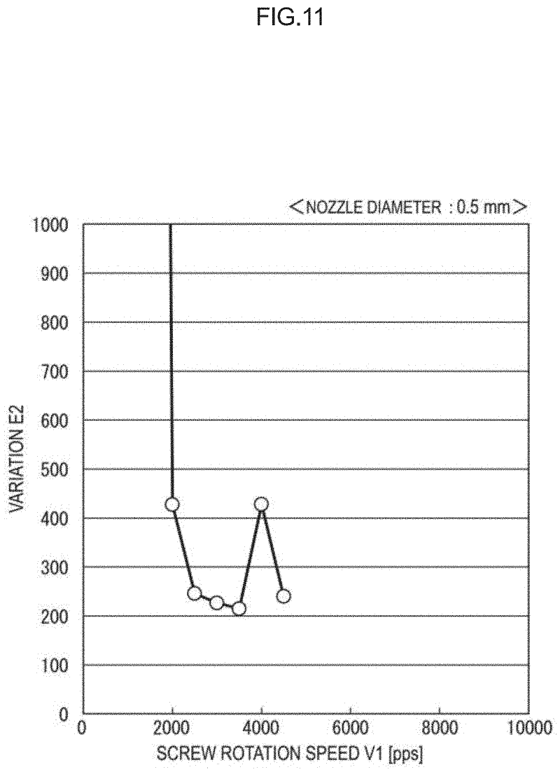

FIG. 7 is a table showing results obtained by performing the procedures (1) and (2) on four types of nozzle 42 of different nozzle diameters D1. Further, FIGS. 8 to 11 are graphs of the results of FIG. 7. In each of FIGS. 8 to 11, the horizontal axis represents the rotational speed V1, and the vertical axis represents the variation E2 in the sealing material cross-sectional area S1. FIG. 8 shows the variation E2 in a case where the nozzle diameter D1 is 0.2 mm, and FIG. 9 shows the variation E2 in a case where the nozzle diameter D1 is 0.3 mm. Further, FIG. 10 shows the variation E2 in a case where the nozzle diameter D1 is 0.4 mm, and FIG. 11 shows the variation E2 in a case where the nozzle diameter D1 is 0.5 mm. As shown in each of FIGS. 8 to 11, it was found that with any of the nozzle diameters D1, the variation E2 becomes smaller within the range of 2000 pps to 4000 pps of the rotational speed V1 of the screw 44. It should be noted that in the present embodiment, a rotational speed V1 of 2000 pps is equivalent to 48 rpm, and 4000 pps equivalent to 96 rpm.

It should be noted that an increase in the rotational speed V1 of the screw 44 leads to an increase in the sealing material cross-sectional area S1. However, as noted above, the variation E2 becomes larger once the rotational speed V1 exceeds about 4000 pps. For this reason, in setting the parameters (i.e. the rotational speed V1, the nozzle diameter D1, and the nozzle gap Z1) concerning the seal dispenser 40, it is preferable to, while setting the rotational speed V1 within the range of 2000 pps to 4000 pps, set the respective values of the nozzle diameter D1 and the nozzle gap Z1 so that the sealing material cross-sectional area S1 approximates to the target value.

Next, a method for producing a liquid crystal panel 11 according to the present embodiment is described. For a seal dispenser 40, the method for producing a liquid crystal panel 11 includes a substrate producing step of producing a CF substrate 21 and an array substrate 30, a calculating step of calculating an equation of a linear function that represents a relationship between a product M1 and a sealing material cross-sectional area S1, a determining step of determining a nozzle diameter D1 and a nozzle gap Z1, a sealing material applying step, a liquid crystal dropping step, a bonding step, and a sealing material curing step. In the substrate producing step, the CF substrate 21 and the array substrate 30 are produced by stacking various types of metal film, insulating film, transparent electrode film and the like on glass substrates by a known photolithography method.

In the calculating step, which is executed after the substrate producing step, as shown in FIGS. 4 and 6, sealing material cross-sectional areas S1 are measured with varied nozzle gaps Z1 and nozzle diameters D1, and on the basis of the measurements, the equation of the line L2 is calculated, for example, by the method of least squares. That is, the relationship between the product M1 of the nozzle diameter D1 of the nozzle 42 and the nozzle gap Z1 and the sealing material cross-sectional area S1 is approximated by a linear function.

In the determining step, which is executed after the calculating step, a product M1 that corresponds to the targeted sealing material cross-sectional area S1 is determined on the basis of the linear function that approximated the relationship between the product M1 and the sealing material cross-sectional area S1. That is, the product M1 is determined using the equation (in the present embodiment, S1=616.18×M1) of the liner L2 calculated in the calculating step. Then, the nozzle diameter D1 and the nozzle gap Z1 are determined on the basis of the product M1 thus determined. Specifically, from among a plurality of selectable nozzle diameters D1 and a plurality of selectable nozzle gaps Z1, a combination of a nozzle diameter D1 and a nozzle gap Z1 that gives a product that is closest to the product M1 is selected. It should be noted that the targeted sealing material cross-sectional area S1 is set on the basis of the product of the gap between the pair of substrates 21 and 30 and the width of the sealing material 24 sandwiched between the pair of substrates 21 and 30. It should be noted that the calculating step and the determining step need only be executed prior to the sealing material applying step and, for example, may be executed prior to the substrate producing step.

In the sealing material applying step, which is executed after the determining step, as shown in FIGS. 2 and 3, a nozzle 42 having the nozzle diameter D1 determined in the determining step is used to apply the sealing material 24 onto the CF substrate 21 while maintaining the nozzle gap Z1 determined in the determining step. Further, in the sealing material applying step, the sealing material 24 is applied onto the CF substrate 21 with the screw 44 set at a rotational speed of 2000 pps to 4000 pps (48 rpm to 96 rpm).

In the liquid crystal dropping step, which is executed after the sealing material applying step, an ODF (one drop fill) method that involves the use of a liquid crystal dropping apparatus is employed to form the liquid crystal layer 23 by dropping liquid crystals into a part of the CF substrate 21 that is surrounded by the sealing material 24. In the bonding step, which is executed after the liquid crystal dropping step, a bonding apparatus is used to bond the CF substrate 21 and the array substrate 30 together under vacuum (under reduced pressure that is lower in pressure than the atmospheric pressure). Thus, the liquid crystal panel 11 is formed.

In the sealing material curing step, which is executed after the bonding step, the sealing material 24 is irradiated with ultraviolet rays through the CF substrate 21 and the array substrate 30, and (or after the irradiation,) heat is applied to the sealing material 24. Thus, the sealing material 24 is cured, whereby the CF substrate 21 and the array substrate 30 are completely fixed to each other via the sealing material 24.

Next, effects of the present embodiment are described. It was found that there is a correlation between the product M1 of the nozzle diameter D1 and the nozzle gap Z1 and the sealing material cross-sectional area S1 and this correlation can be approximated by a linear function. For this reason, by determining, on the basis of the linear function thus approximated, a nozzle diameter D1 and a nozzle gap Z1 that correspond to the target sealing material cross-section area S1 and applying the sealing material 24 onto the CF substrate 21 on the basis of the nozzle diameter D1 and nozzle gap Z1 thus determined, the sealing material 24 can be applied with a desired cross-sectional area onto the CF substrate 21.

Further, it was found that variation in the sealing material cross-sectional area S1 that is applied onto the CF substrate 21 is reduced by setting the rotational speed of the screw 44 between 48 to 96 ppm. For this reason, variation in the sealing material cross-sectional area S1 can be further reduced by setting the rotational speed of the screw 44 within the aforementioned range.

### Other Embodiments

The present technology is not limited to the embodiment described above with reference to the drawings. The following embodiments may be included in the technical scope.

(1) Although the embodiment described above has illustrated the application of the sealing material 24 onto the CF substrate 21, this is not intended to impose any limitation. For example, the sealing material 24 may be applied onto the array substrate 30. However, since the array substrate 30 has an uneven surface due to a wiring pattern, there tend to be variations in the measurement of the nozzle gap Z1 by the position sensor 46, making it hard to maintain the nozzle gap Z1. In this respect, when the sealing material 24 is applied onto the CF substrate 21, which has a flatter surface, the position sensor 46 yields stable measurements, making it easy to maintain the nozzle gap Z1. This makes it possible further increase accuracy of drawing of the sealing material 24.

(2) The values of the nozzle diameter and the nozzle gap are not limited to the values illustrated in the embodiment described above.

(3) Although the embodiment described above has illustrated the ODF (one drop fill) method, by which the sealing material 24 is drawn onto the CF substrate 21 to circle around in the shape of an endless ring and, before the CF substrate 21 and the array substrate 30 are bonded together, liquid crystals are dropped into the part surrounded by the sealing material 24, this is not intended to impose any limitation. For example, the liquid crystal layer 23 may be formed by using a vacuum injection method by which a sealing material is drawn to have an opening that serves as an inlet through which liquid crystals are injected and, after the CF substrate 21 and the array substrate 30 have been bonded together, the liquid crystals are charged through the inlet into the part surrounded by the sealing material.

1. A method of producing a display panel using a seal dispenser that includes a nozzle and moves over a substrate of the display panel while discharging a sealing material onto the substrate to apply the sealing material onto the substrate, the sealing material applied onto the substrate having a sealing material cross-sectional area that is a cross-sectional area of the sealing material cut along a plane orthogonal to a moving direction of the nozzle and a spacing between the substrate and a tip of the nozzle being defined as a nozzle gap, the method comprising:
a determining step of determining, on the basis of a linear function that approximates a relationship between a product of a nozzle diameter of the nozzle and the nozzle gap and the sealing material cross-sectional area, the nozzle diameter and the nozzle gap that correspond to the sealing material cross-sectional area that is targeted; and
a sealing material applying step of, by using the nozzle having the nozzle diameter determined in the determining step, being executed after the determining step and applying the sealing material onto the substrate while maintaining the nozzle gap determined in the determining step.

2. The method according to claim 1, wherein the seal dispenser includes a cylinder having the nozzle and a screw built in the cylinder and is configured such that the screw rotates to cause the nozzle to discharge the sealing material in the cylinder, and
in the sealing material applying step, the sealing material is applied onto the substrate with the screw set at a rotational speed of 48 rpm to 96 rpm.
